(19) United States
(12) Patent Application Publication
(10) Pub. No.: US 2008/0026713 A1
(43) Pub. Date: Jan. 31, 2008

(54) Methods and apparatus for a wireless surveillance system

(75) Inventors: Ramesh V. Sekhar, San Jose, CA (US); Anthony Bartolo, Saratoca, CA (US)

Correspondence Address: FAY KAPLUN & MARCIN, LLP, 15O BROADWAY, SUITE 702, NEW YORK, NY, 10038, US

(73) Assignee: Symbol Technologies, Inc.

(21) Appl. No.: 11/495,264

(22) Filed: Jul. 27, 2006

(51) Int. Cl. H04B 1/18

(52) U.S. Cl. 455/187.1

(57) ABSTRACT

A wireless surveillance system includes an imaging device configured to produce an image; a wireless network device (such as an access port or mobile unit) connected to the imaging device; and a wireless switch coupled to the wireless network device and a network, the wireless switch configured to communicate with the wireless network device and route the image to a computer coupled to the network. Image processing may be performed, for example, by the wireless switch, and the image may be used for asset tracking and the like.

### TECHNICAL FIELD

The present invention relates generally to wireless local area networks (WLANs) and, more particularly, to a WLAN with surveillance capabilities.

### BACKGROUND

In recent years, there has been a dramatic increase in demand for mobile connectivity solutions utilizing various wireless components and wireless local area networks (WLANs). This generally involves the use of wireless access points that communicate with mobile devices using one or more RF channels. Such wireless network components are distributed throughout the working environment.

At the same time, large department stores, malls, warehouses, and the like commonly deploy various types of security and surveillance devices throughout the environment. These video cameras, power supplies, computer systems, etc. are positioned in numerous locations to monitor activity within the establishment. Such systems are costly, difficult to set up, and tend to consume significant amount of space.

Accordingly, it is desirable to provide systems that are capable of wirelessly providing surveillance of assets, individuals, or other entities and which work in connection with existing wireless networks. Furthermore, other desirable features and characteristics of the present invention will become apparent from the subsequent detailed description and the appended claims, taken in conjunction with the accompanying drawings and the foregoing technical field and background.

### BRIEF SUMMARY

The present invention relates to the use of imaging devices in conjunction with wireless devices such as access ports, mobile units, etc. In accordance with one embodiment, a wireless surveillance system includes an imaging device configured to produce an image; a wireless network device connected to the imaging device; and a wireless switch coupled to the wireless network device and a network, the wireless switch configured to communicate with the wireless network device and route the image to a computer coupled to the network. Image processing may be performed, for example, by the wireless switch, and the image may be used for asset tracking, feature recognition, and the like.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a wireless network useful in describing the present invention; and

FIG. 2 is an overview of example wireless surveillance components in accordance with one embodiment.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

In general, one or more imaging devices are incorporated into various WLAN components, and are configured to work in conjunction with software modules within the imaging device or otherwise distributed throughout the network to provide surveillance, asset tracking, and the like.

Without loss of generality, in the illustrated embodiment, many of the functions usually provided by a traditional access point (e.g., network management, wireless configuration, and the like) are concentrated in a corresponding wireless switch. It will be appreciated that the present invention is not so limited, and that the methods and systems described herein may be used in conjunction with traditional access points or any other device that communicates via multiple RF channels.

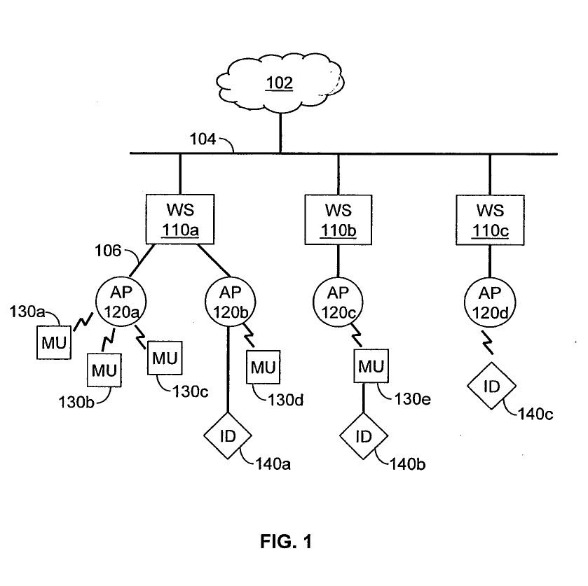

Referring to FIG. 1, one or more switching devices 110 (alternatively referred to as “wireless switches,” “WS,” or simply “switches”) are coupled to a network 104 (e.g., an Ethernet network coupled to one or more other networks or devices, indicated by network cloud 102). One or more wireless access ports 120 (alternatively referred to as “access ports” or “APs”) are configured to wirelessly connect to one or more mobile units 130 (or “MUs”). APs 120 are suitably connected to corresponding switches 110 via communication lines 106 (e.g., conventional Ethernet lines). One or more imaging devices 140 are suitably coupled to the network 104 via, for example, APs 120. Any number of additional and/or intervening switches, routers, servers and other network components may also be present in the system.

A particular AP 120 may have a number of associated MUs 130. For example, in the illustrated topology, MUs 130(a), 130(b), and 130(c) are associated with AP 120(a), while MU 130(e) is associated with AP 120(c). Furthermore, one or more APs 120 may be connected to a single switch 110. Thus, as illustrated, AP 120(a) and AP 120(b) are connected to WS 110(a), and AP 120(c) is connected to WS 110(b).

Each WS 110 determines the destination of packets it receives over network 104 and routes that packet to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110.

AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

As mentioned briefly above, one or more imaging devices 140 are connected to the network to provide wireless surveillance. In this regard, the various tasks described below in connection with imaging devices 140 may be performed by software, hardware, firmware, or any combination thereof, and may be located in the AP, the MU, the WS, a computer system connected to network 104, or any combination thereof.

Imaging device (or simply “ID”) 140 may include any combination of hardware/software/firmware, image processing systems, etc. capable of capturing some form of image (e.g., a digital image) of the environment within its field of view. Imaging device may therefore be an optical device (video camera), a thermal (infrared) imager, or any other imaging device now known or developed in the future.

In one embodiment, imaging device 140 is connected (e.g., through a wired connection) to an AP 120. Imaging device 140(a) in FIG. 1, for example, is connected to AP 120(b). In such an embodiment, imaging device 140 may be remote from AP 120, adjacent to the AP, or simply incorporated directly into the housing of the AP. In this regard, the nature of housing for networked devices is well known, and need not be described in detail herein. Furthermore, multiple IDs may be attached to a single network device.

In an alternate embodiment, imaging device 140 is connected to an MU. As illustrated in FIG. 1, for example, imaging device 140 is connected to MU 130(e). As with the previous embodiment, imaging device 140 may be remote from the MU, adjacent to the MU, or incorporated directly into the housing of the MU. Such devices are easy to relocate and deploy in order to fit the needs of the surveillance system.

In yet another embodiment, imaging device 140 itself functions as an MU. Imaging device 140(c) in FIG. 1, for example, functions as an MU with respect to AP 120(d). In this embodiment, imaging device includes suitable hardware and software necessary to establish and maintain a wireless connection in accordance with known principles.

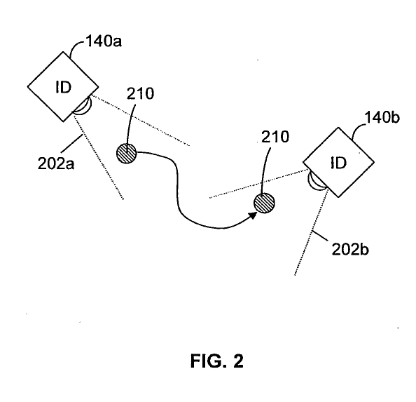

FIG. 2 depicts two IDs 140(a) and 140(b) positioned within an environment. Each of the two IDs has respective fields of view 202(a) and 202(b). It will be appreciated that the IDs may have any convenient field of view, ranging from narrow to wide-angle or fish-eye, depending upon the application. There may be any number of cameras situated at a variety of orientations within the environments, and their fields of view may (and most likely) partially overlap. In one embodiment, IDs 140 may be oriented manually or automatically—e.g., through a web interface or other suitable software module. That is, an ID may be configured to scan over a range of viewpoints, or be remotely controlled to cover various regions of the environment.

As shown, an entity (e.g., an individual, asset, etc.) 210 may be present within field of view 202(a) of ID 140(a) initially, and then be relocated to within field of view 202(b) of ID 140(b). That is, ID 140(a) will produce an image of entity 210, process the image, then transmit over the network (not shown) through the WLAN device to which it is connected. In the interest of simplicity, the various MUs and APs that are connected to or otherwise communicate with IDs 140(a) and 140(b) are not shown in FIG. 2. When entity 210 is relocated to another position, ID 140(b) may similarly produce and transmit and image as it enters field of view 202(b) (and exits field of view 202(a)).

The position and orientation of the various IDs 140 may be known a priori (i.e., through a fixed installation position) or determined through any convenient means, for example, through the use of RFIDs, GPS, triangulation, analysis of their respective images, or the like. In the case where an ID 140 is directly incorporated into or attached to the housing of an MU or AP, the location of the ID 140 will be known to the extent that the attached MU or AP is also known.

As mentioned above, images produced by IDs 140 may be processed using one or more image processing algorithms known in the art, and may be analyzed to accomplish feature recognition, object identification, or the like. The image processing may be performed by the ID itself, the WLAN component to which it is connected, the WS, or another computer accessible over the network—for example, a central security station or the like. In general, a computer-implemented subsystem comprising any number of components may be used.

Using known image processing techniques, for example, IDs may be used to track an entity as it moves through the environment. When an entity is recognized, an object identifier may be assigned from a database, and its location noted. In the event that the entity is moving outside of or within a predetermined region, an alarm may produced to indicate that the movement has occurred.

It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A wireless surveillance system comprising:
an imaging device configured to produce an image;
a wireless network device connected to the imaging device;
a wireless switch coupled to the wireless network device and a network, the wireless switch configured to communicate with the wireless network device and route the image to a computer connected to the network.

2. The system of claim 1, wherein the wireless network device has a housing and the imaging device is incorporated within the housing of the wireless network device.

3. The system of claim 1, wherein the imaging device is configured to produce an optical video image.

4. The system of claim 1, wherein the imaging device is configured to produce a thermal image.

5. The system of claim 1, wherein the wireless network device is a mobile unit.

6. The system of claim 1, wherein the wireless network device is an access port.

7. The system of claim 1, wherein the wireless network device operates in accordance with an IEEE 802.11 standard.

8. The system of claim 1, further including a computer-implemented image processing subsystem.

9. The system of claim 8, wherein the computer-implemented image processing subsystem is configured to identify and track an entity using the image produced by the imaging device.

10. A surveillance method comprising:
providing a plurality of imaging devices within an environment;
providing one or more access ports coupled to the plurality of imaging devices;
providing a wireless switch coupled to a network;
producing, via one of the imaging devices, a digital image;
communicating the digital image to the access port;
communicating the digital image to the wireless switch; and
processing the digital image to determine the identity of an entity represented within the digital image;

11. The method of claim 10, wherein producing the digital image includes producing an optical video image.

12. The method of claim 10, wherein producing the digital image includes producing a thermal image.

13. The method of claim 1, wherein the access port operates in accordance with an IEEE 802.11 standard.

14. The method of claim 10, further including tracking the entity using at least one second image produced by one of the imaging devices.

15. The method of claim 10 wherein processing the digital image is performed by the wireless switch.

16. An access port configured to wirelessly receive data from a mobile unit and send the data to a wireless switch
